(19) United States
(12) Patent Application Publication
(10) Pub. No.: US 2015/0280326 A1
(43) Pub. Date: Oct. 1, 2015

(54) REFLECTOR, REFLECTIVE COATING, AND REFLECTING BODY DETECTING DEVICE

(71) Applicant: MITSUBISHI SPACE SOFTWARE CO., LTD., Minato-ku, Tokyo (JP)

(72) Inventor: Motofumi Arii, Kanagawa (JP)

(73) Assignee: Mitsubishi Space Software Co., Ltd., Tokyo (JP)

(21) Appl. No.: 14/441,788

(22) PCT Filed: Nov. 7, 2013
(86) PCT No.: PCT/JP2013/080110

§ 371 Date: May 8, 2015

(30) Foreign Application Priority Data
Nov. 8, 2012 (JP) 2012-245928

(51) Int. Cl. H01Q 15/16; H01Q 1/28; G01S 7/02

(52) U.S. Cl. CPC H01Q 15/16; G01S 7/024; H01Q 1/288; G01S 2013/9076

(57) ABSTRACT

A reflector has a spherical main body and a plurality of conductor wires projecting radially from a central portion of the main body as the center. The reflector has a spherical shape like a sea urchin or chestnut in burr as a whole. At least any one conductor wire out of the plurality of conductor wires causes a radio wave entering while oscillating in a specific oscillating direction, to oscillate in a direction different from the specific oscillating direction, so as to reflect the radio wave in an incident direction in which the wave has entered. A radar device mounted on a flying object transmits a radio wave oscillating in the specific oscillating direction, and receives a radio wave oscillating in a direction different from the specific oscillating direction. If the signal intensity of the received radio wave is higher than a detection threshold, the radar device determines that there is a reflector in the direction the radio wave has been transmitted.

### TECHNICAL FIELD

The present invention relates to a reflector, reflective coating, and a reflecting body detecting device for detecting a mobile body.

### BACKGROUND ART

FIG. 9 illustrates a conventional reflector 90.

The reflector 90 (an example of a reflector) is attached to a vessel (particularly a small-sized vessel) such as a fishing boat or pleasure boat.

For example, when searching for a shipwreck, a radar device installed on the coast or on the sea transmits a radar wave (an example of a radio wave) and receives the radar wave which is reflected by the reflector 90 attached to the vessel, and scattered backward. The position of the vessel is thus detected.

The reflector 90 illustrated in FIG. 9 is called a trihedral corner reflector as well, and has a plurality of trihedral corners 91. The three surfaces of each trihedral corner 91 are orthogonal in order to reflect a radar wave entering in any incident direction, strongly in the incident direction.

The trihedral corner 91 reflects the incident radar wave by an incident surface and further reflects the radar wave reflected by the incident surface, by a surface that is different from the incident surface, so as to reflect the radar wave in the same direction as the incident direction of the radar wave.

In case of searching a wide area the radar wave from the coast or sea cannot reach, however, the radar wave must be transmitted and received up in the sky.

In this case, the radar device up in the sky also receives a radar wave that was reflected by the sear surface and scattered backward. Hence, it is difficult to distinguish whether the received radar wave was reflected by the reflector 90 on the vessel, or by the sear surface.

Concerning the reflector, patent literatures as follows are published.

Patent Literature 1 discloses a dipole lattice serving to obtain optimum wide-band characteristics.

Patent Literature 2 discloses a reflecting plate having a concave shape.

Patent Literature 3 discloses a reflecting mirror having a plurality of linear conductors arranged parallel to each other planarly.

Patent Literature 4 discloses a reflect array serving to reflect the radio wave with a desired frequency.

### CITATION LIST

### Patent Literature

Patent Literature 1: JP 61-065605

Patent Literature 2: JP 62-118612

Patent Literature 3: JP 2002-171121

Patent Literature 4: JP 2011-109264

### SUMMARY OF INVENTION

### Technical Problem

It is an object of the present invention to enable detection of a radio wave reflected by a reflector even when the radio wave is transmitted and received up in the sky, for example.

### Solution to Problem

A reflector according to the present invention includes:

a main body; and

a plurality of linear radio wave scattering bodies provided to the main body in different orientations,

wherein at least any one radio wave scattering body out of the plurality of radio wave scattering bodies causes a radio wave entering while oscillating in a specific oscillating direction, to oscillate in a direction different from the specific oscillating direction, to reflect the radio wave in an incident direction in which the radio wave has entered.

The main body forms a three-dimensional shape, and the plurality of radio wave scattering bodies are arranged on an entire outer surface of the main body.

The plurality of radio wave scattering bodies project from the main body such that the plurality of radio wave scattering bodies are arranged on the entire outer surface of the main body.

The plurality of radio wave scattering bodies project from the main body radially to have a central portion of the main body as a center.

The main body forms a spherical shape, and the plurality of radio wave scattering bodies project from the main body radially to have the central portion of the main body as the center, so that the reflecting body forms a spherical shape as a whole.

The main body forms a three-dimensional shape, and the plurality of radio wave scattering bodies project from the main body radially to have a central portion of the main body as a center, so that the plurality of radio wave scattering bodies are arranged on part of an outer surface portion of the main body.

The main body is made of a radio wave transmitting material through which the radio wave is transmitted.

The reflector is attached to a mobile body being a detection target.

The main body is a planar sheet, and the plurality of radio wave scattering bodies are arranged on the sheet planarly in different orientations.

The plurality of radio wave scattering bodies are arranged on an entire surface of the sheet in random orientations.

The sheet is made of a radio wave transmitting material through which the radio wave is transmitted.

The reflector is provided to a surface of at least part of the mobile body being a detection target.

A reflective coating according to the present invention contains a plurality of linear radio wave scattering bodies, wherein when the reflective coating is applied, at least any one radio wave scattering body out of the plurality of radio wave scattering bodies causes the radio wave entering while oscillating in a specific oscillating direction, to oscillate in a direction different from the specific oscillating direction, to reflect the radio wave in an incident direction in which the radio wave has entered.

The reflective coating is applied to a surface of at least part of the mobile body being a detection target.

A reflecting body detecting device according to the present invention includes:

a polarized wave transmitting part that transmits a radio wave oscillating in a specific oscillating direction, as a transmission polarized wave;

a polarized wave receiving part that receives a radio wave, being the transmission polarized wave transmitted by the polarized wave transmitting part and reflected where the transmission polarized wave travels to, to be scattered backward, as the reception polarized wave; and

a reflecting body detecting part that determines whether or not a reflecting body which causes the transmission polarized wave to oscillate in an oscillating direction different from the oscillating direction of the transmission polarized wave, to reflect the transmission polarized wave, is located where the transmission polarized wave travels to, based on the reception result of a reception polarized wave oscillating in an oscillating direction that is different from the oscillating direction of the transmission polarized wave, among the reception polarized waves received by the polarized wave receiving part.

The reflecting body detecting device is provided to a flying object which flies up in the sky above the reflecting body, and transmits the transmission polarized wave and receives the reception polarized wave up in the sky above the reflecting body.

### Advantageous Effects of Invention

According to the present invention, a radio wave reflected by a reflector can be detected even when the radio wave is transmitted and received up in the sky, for example.

### BRIEF DESCRIPTION OF DRAWINGS

FIG. 1 is a schematic view illustrating a method of searching for a vessel to which a reflector 10 according to Embodiment 1 is attached.

FIG. 2 is a functional configuration diagram of a SAR satellite 22 and a SAR processing device 30 according to Embodiment 1.

FIG. 3 includes schematic illustrations concerning polarized wave observation according to Embodiment 1.

FIG. 4 includes graphs representing the simulation result of polarized wave observation according to Embodiment 1.

FIG. 5 illustrates an example of the reflector 10 according to Embodiment 1.

FIG. 6 illustrates other examples of the reflector 10 according to Embodiment 1.

FIG. 7 illustrates still other examples of the reflector 10 according to Embodiment 1.

FIG. 8 illustrates a reflecting sheet 50 according to Embodiment 2.

FIG. 9 illustrates a conventional reflector 90.

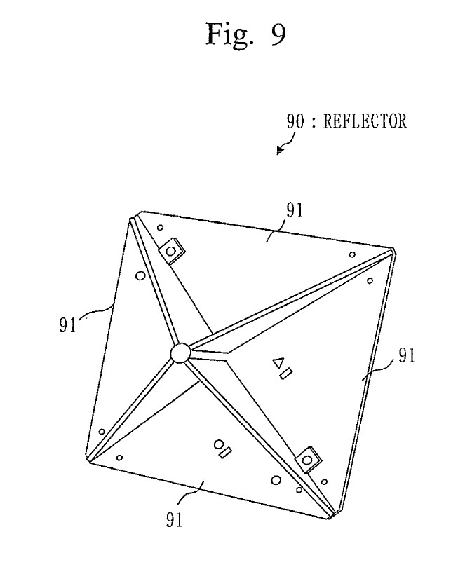

### DESCRIPTION OF EMBODIMENTS

### Embodiment 1

An embodiment will be described in which a radio wave reflected by a reflector can be detected even when the radio wave is transmitted and received up in the sky.

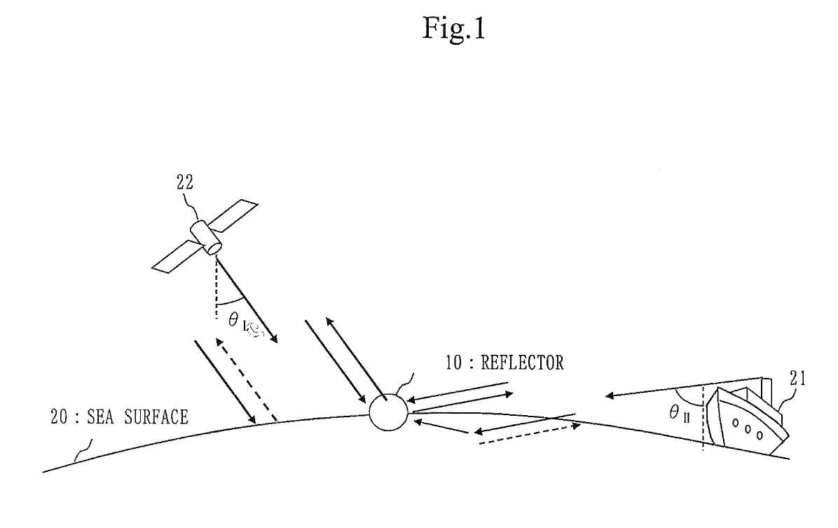

FIG. 1 is a schematic view illustrating a method of searching for a vessel to which a reflector 10 according to Embodiment 1 is attached.

The outline of the method of searching for the vessel to which the reflector 10 according to Embodiment 1 is attached will be described with reference to FIG. 1. In FIG. 1, arrows indicate radar waves (an example of a radio wave or polarized wave).

In case of searching for a vessel (not illustrated) to which the reflector 10 is attached, a search vessel 21 on which a radar device is mounted transmits the radar wave at sea, and receives the radar wave reflected by a sea surface 20 or the reflector 10 and scattered backward.

Hereinafter, the incident angle of the radar wave refers to an angle formed by the vertical direction and the traveling direction of the transmitted radar wave.

An incident angle θ_{H} of the radar wave transmitted by the search vessel 21 is a high-incident angle, forming a small angle (close to horizontal) with respect to the sea surface 20.

For this reason, the radar wave transmitted by the search vessel 21 can be easily mirror-surface reflected by the sea surface 20 and is less scattered backward by the sea surface 20. Namely, the intensity of the radar wave reflected by the sea surface 20 and scattered backward is sufficiently lower than the intensity of the radar wave reflected by the reflector 10 and scattered backward.

Hence, when the search vessel 21 receives a strong radar wave, probably, a vessel to which the reflector 10 is attached exists in the transmitting direction of the radar wave.

The same vessel searching method applies to a case of searching for a vessel not by the search vessel 21 on the sea but by a radar device installed on the coast (or on the ground other than the coast).

On the sea or the coast, however, the radar wave can be transmitted or received only within a limited range, and accordingly a wide range cannot be searched.

Hence, in order to search a wide range, the radar wave must be transmitted and received up in the sky.

In view of this, a SAR satellite 22 on which a radar device is mounted transmits the radar wave up in the sky, and receives the radar wave reflected by the sea surface 20 or reflector 10 and scattered backward.

The SAR satellite 22 is an artificial satellite on which a SAR (synthetic aperture radar) is mounted, and is utilized, for example, to generate a radar image of the earth.

Note that a radar device may be mounted on a flying object such as an artificial satellite other than the SAR satellite 22, an airplane, or a balloon, to perform vessel searching.

An incident angle θ_{L} of a radar wave transmitted by the SAR satellite 22 is a low-incident angle, forming a large angle (close to vertical) with respect to the sea surface 20.

Hence, when the SAR satellite 22 transmits a radar wave, the radar wave is largely scattered backward by the sea surface 20. The intensity of the radar wave reflected by the sea surface 20 and scattered backward is equal to or larger than the intensity of the radar wave reflected by the reflector 10 and scattered backward.

Among radar waves reflected by the sea surface 20 and scattered backward, a radar wave (for example, a vertically polarized wave) that oscillates in a direction different from the oscillating direction of a transmitted radar wave (for example, a horizontally polarized wave) and is scattered backward has a sufficiently small intensity.

Hence, the reflector 10 according to Embodiment 1 has the following features.

The reflector 10 reflects a radar wave entering while oscillating in a specific oscillating direction (for example, the horizontal direction), by causing the radar wave to oscillate in a direction different from the specific oscillating direction.

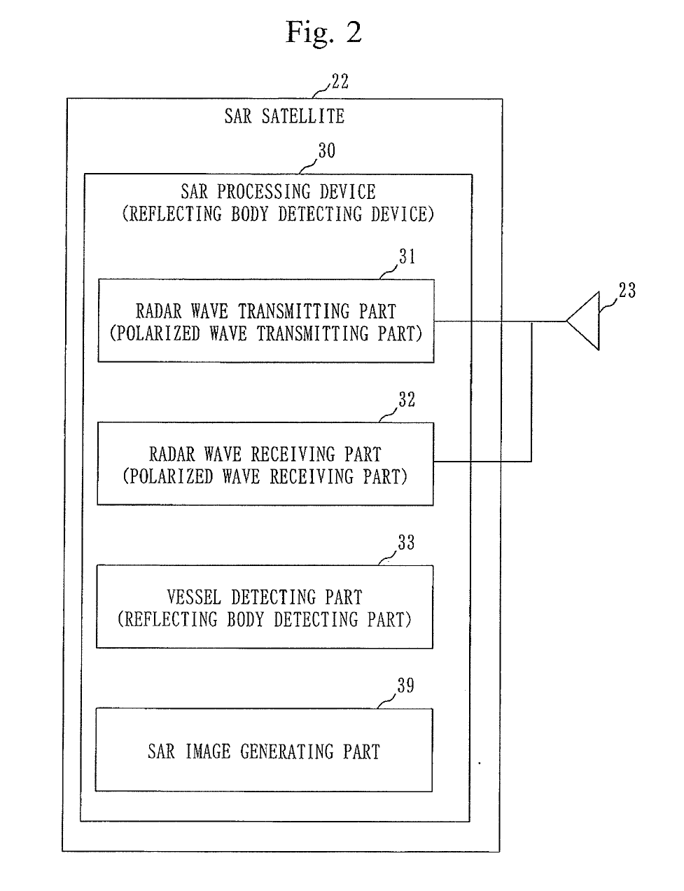

FIG. 2 is a functional configuration diagram of the SAR satellite 22 and a SAR processing device 30 according to Embodiment 1.

The functional configuration of the SAR satellite 22 and SAR processing device 30 according to Embodiment 1 will be described with reference to FIG. 2.

The SAR satellite 22 has a SAR 23 and the SAR processing device 30 (an example of a reflecting body detecting device). The SAR processing device 30 has a radar wave sending part 31 (an example of a polarized wave transmitting part), a radar wave receiving part 32 (an example of a polarized wave receiving part), a vessel detecting part 33 (an example of a reflecting body detecting part), and a SAR image generating part 39.

The radar wave sending part 31 controls the SAR 23 so as to send (transmit) from the SAR 23 a radar wave (for example, a horizontally polarized wave) oscillating in a specific oscillating direction.

The radar wave sent by the radar wave sending part 31 is reflected where the radar wave has propagated to, and is scattered backward, to reach the SAR 23. The radar wave receiving part 32 receives the radar wave that reaches the SAR 23.

The vessel detecting part 33 determines whether or not the vessel (an example of the reflecting body) to which the reflector 10 is attached is located where the radar wave travels to, based on the reception result of a radar wave oscillating in an oscillating direction (for example, a vertically polarized wave) that is different from the oscillating direction of the transmitted radar wave, out of the radar waves received by the radar wave receiving part 32.

For example, the vessel detecting part 33 compares the signal intensity (also called a signal value, amplitude value, or power value) of the received radar wave with a predetermined detection threshold. If the reception intensity of the received radar wave is larger than the detection threshold, the vessel detecting part 33 determines that the vessel to which the reflector 10 is attached is located where the radar wave propagates to.

The SAR image generating part 39 performs SAR image processes such as range compression and azimuth compression for the analog signal of the radar wave received by the radar wave receiving part 32 or for a digital signal obtained by converting the analog signal, thus generating a SAR image. The generated SAR image expresses the sea surface 20 and vessels located within a range where the radar wave is radiated.

Note that a vessel detecting device (an example of the reflecting body detecting device) provided with the radar, the radar wave sending part 31, the radar wave receiving part 32, and the vessel detecting part 33 may be installed on a flying object other than the SAR satellite 22, the search vessel 21, a facility on the ground (for example, the coast), or the like, thereby searching for vessels.

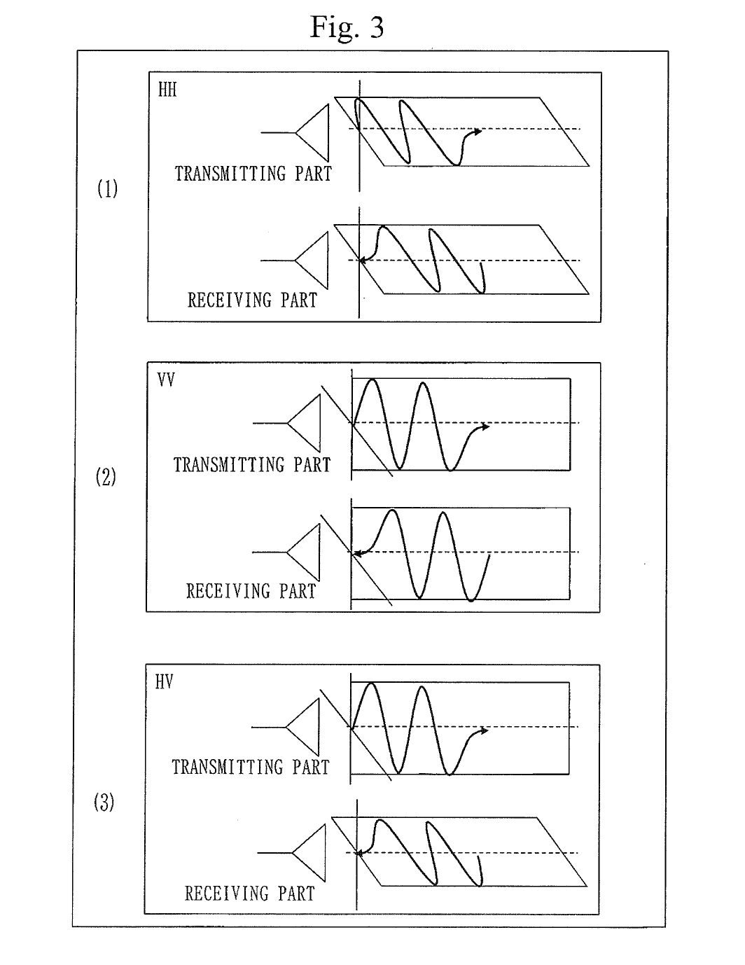

FIG. 3 includes schematic illustrations concerning polarized wave observation according to Embodiment 1.

In FIG. 3, (1) expresses HH observation where a sending part sends a horizontally polarized wave (H) oscillating in the horizontal direction and a receiving part receives a horizontally polarized wave (H).

In FIG. 3, (2) expresses VV observation where the sending part sends a vertically polarized wave (V) oscillating in the vertical direction and the receiving part receives a vertically polarized wave (V).

In FIG. 3, (3) expresses HV observation where the sending part sends a horizontally polarized wave (H) and the receiving part receives a vertically polarized wave (V).

For example, the vessel detecting part 33 of the SAR processing device 30 (see FIG. 2) detects a vessel to which the reflector 10 is attached, by HV observation expressed in (3) of FIG. 3.

More specifically, the vessel detecting part 33 detects the vessel to which the reflector 10 is attached, based on the reception result of the radar wave (V) oscillating in an oscillating direction different from that of the sent radar wave (H).

Note that the vessel detecting part 33 may detect the vessel to which the reflector 10 is attached, by another polarized wave observation where the oscillating direction of the sent radar wave and the oscillating direction of the received radar wave are different.

For example, the vessel detecting part 33 may detect the vessel to which the reflector 10 is attached, by VH observation where the sending part sends a vertically polarized wave (V) and the receiving part receives a horizontally polarized wave (H).

The angles of the oscillating directions of the horizontally polarized wave (H) and vertically polarized wave (V) may have predetermined margins. For example, a polarized wave that oscillates in a range of −10 degrees to +10 degrees with respect to the horizontal direction may be treated as the horizontally polarized wave (H). The same applies to the vertically polarized wave (V).

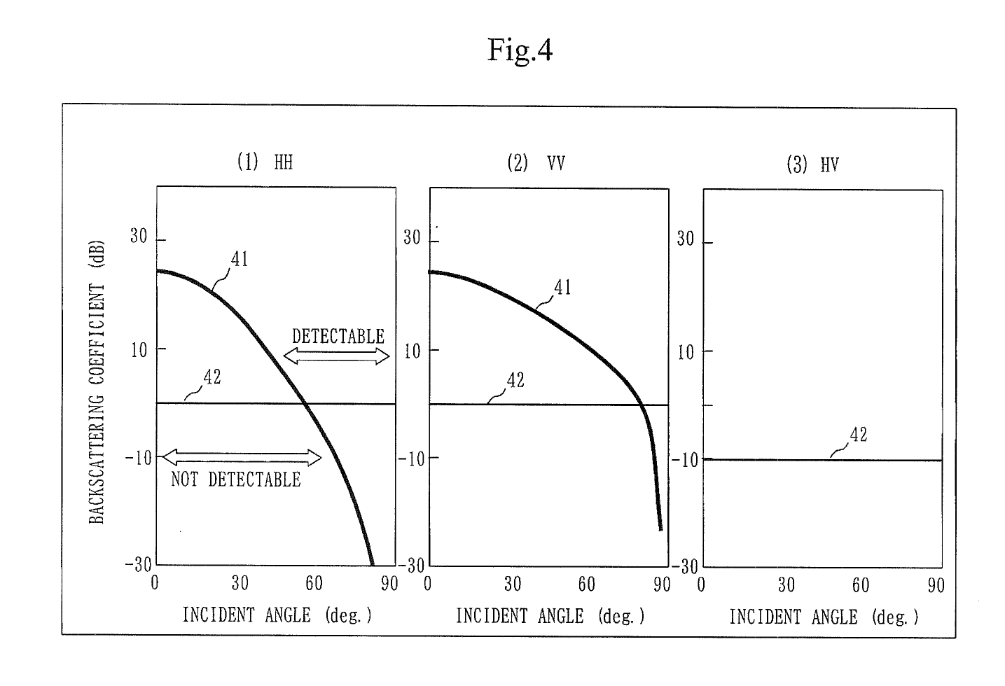

FIG. 4 includes graphs representing the simulation result of polarized wave observation according to Embodiment 1.

In FIG. 4, (1) represents the simulation result of HH observation. In FIG. 4, (2) represents the simulation result of VV observation. In FIG. 4, (3) represents the simulation result of HV observation. In each graph, the axis of ordinate represents a backscattering coefficient, and the axis of abscissa represents an incident angle. The backscattering coefficient is a coefficient expressing the signal intensity of a radar wave scattered backward and received.

A thick curve included in each graph indicates the backscattering coefficient of a radar wave reflected by the sea surface 20 and scattered backward (to be referred to as “sea-surface scattering 41” hereinafter). A thin horizontal line indicates the backscattering coefficient of a radar wave reflected by the reflector 10 and scattered backward (to be referred to as “reflector scattering 42” hereinafter).

Where the backscattering coefficient of the reflector scattering 42 is larger than the backscattering coefficient of the sea-surface scattering 41, the backscattering coefficient of the received radar wave is compared with a detection threshold which is larger than the backscattering coefficient of the sea-surface scattering 41 and smaller than the backscattering coefficient of the reflector scattering 42, thereby distinguishing the reflector scattering 42, so that the reflector 10 can be detected.

Namely, if the backscattering coefficient of the received radar wave is larger than the detection threshold, the received radar wave is the reflector scattering 42, and the reflector 10 exists in the direction in which the radar wave is received (the same as the direction in which the radar wave is sent).

As illustrated in (1) and (2) of FIG. 4, where the incident angle is small in HH observation or VV observation, that is, where the radar wave is sent and received up in the sky, the backscattering coefficient of the sea-surface scattering 41 is larger than the backscattering coefficient of the reflector scattering 42, and accordingly the reflector scattering 42 cannot be distinguished.

As in HV observation illustrated in (3) of FIG. 4, where the oscillating direction of the sent radar wave and the oscillating direction of the received radar wave are different, no sea-surface scattering 41 occurs, so that the reflector 10 can be detected by distinguishing the reflector scattering 42.

Hence, the reflector 10 changes the oscillating direction of the incident radar wave and scatters the incident radar wave backward. The vessel detecting part 33 of the SAR processing device 30 (see FIG. 2) detects the vessel to which the reflector 10 is attached, based on the reception result (backscattering coefficient) of the radar wave oscillating in an oscillating direction different from the sent radar wave.

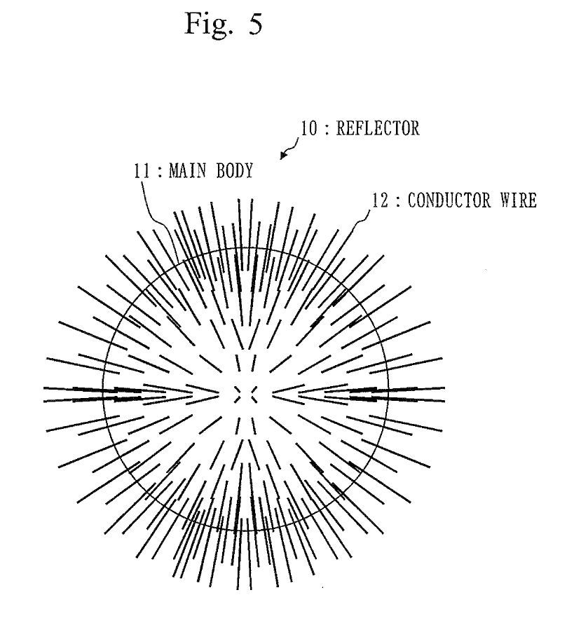

FIG. 5 illustrates an example of the reflector 10 according to Embodiment 1.

An example of the reflector 10 according to Embodiment 1 will be described with reference to FIG. 5.

The reflector 10 has a spherical main body 11 and a plurality of conductor wires 12 projecting from the main body 11 radially to have the central portion of the main body 11 as the center.

The reflector 10 forms a spherical shape as a whole like a sea urchin or chestnut in burr.

The plurality of conductor wires 12 oscillate the radar waves coming incident on the reflector 10 and reflect the radar waves in directions that match the orientations of the conductor wires 12.

The conductor wires 12 are thin elongated wire-like (or rod-like) conductors and called dipole or dipole antennae as well. Metal wires to which a current is supplied are an example of the conductor wires 12. In place of the conductor wires 12, dielectric wires (for example, thin elongated wooden members) made of a dielectric material may be used. The conductor wires 12 and dielectric wires are examples of a radio wave scattering body that reflects and scatters the radio wave.

The larger the number of conductor wires 12 projecting from the main body 11, the better.

The longer the portions of the conductor wires 12 projecting from the main body 11, the better. The thinner the conductor wires 12, the better.

For example, each conductor wire 12 is preferably longer than the wavelength of the radar wave. However, the length of each conductor wire 12 may be almost the same as the wavelength of the radar wave.

The sectional width (for example, diameter) of each conductor wire 12 is preferably smaller than one tenth the wavelength of the radar wave. However, the sectional width of each conductor wire 12 may be almost one tenth the wavelength of the radar wave.

For example, where the radar wave is an X-band (wavelength: 3 cm) radio wave, the length of each conductor wire 12 is almost 3 cm or more, and the sectional width of each conductor wire 12 is almost 3 mm or less.

Where the radar wave is an L-band (wavelength: 24 cm) radio wave, the length of each conductor wire 12 is almost 24 cm or more, and the sectional width of each conductor wire 12 is almost 24 mm or less.

The section of each conductor wire 12 may be of any shape, for example, circular, triangular, square, or any other polygonal shape. Namely, each conductor wire 12 may have any shape, for example, a circular columnar shape, a triangular columnar shape, a square columnar shape, or any other polygonal columnar shape.

By arranging the plurality of conductor wires 12 radially, the plurality of conductor wires 12 can be arranged in different orientations.

Thus, in whichever direction the radar wave may enter, at least one conductor wire 12 can change the oscillating direction of the incident radar wave and scatter the incident radio wave backward in the incident direction.

The main body 11 is made of a radio wave transmitting material, such as expanded polystyrene or a plastic material through which the radar wave can be transmitted.

By forming the main body 11 using the radio wave transmitting material, the radar wave entering the reflector 10 can be reflected by the conductor wires 12 provided to the rear side of the main body 11 and be scattered backward.

For example, the reflector 10 is formed by piercing a plurality of wires (an example of the conductor wires 12) into an expanded polystyrene spherical body (an example of the main body 11).

The reflector 10 may be formed by piercing thin elongated skewer-like wooden members (an example of the dielectric wires), in place of the plurality of wires, into an expanded polystyrene spherical body.

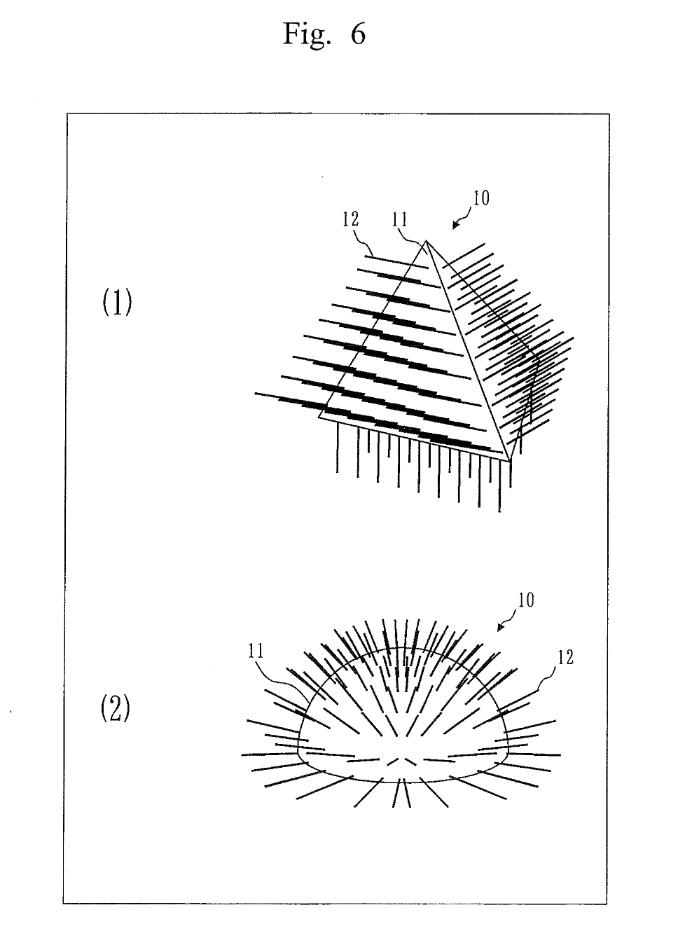

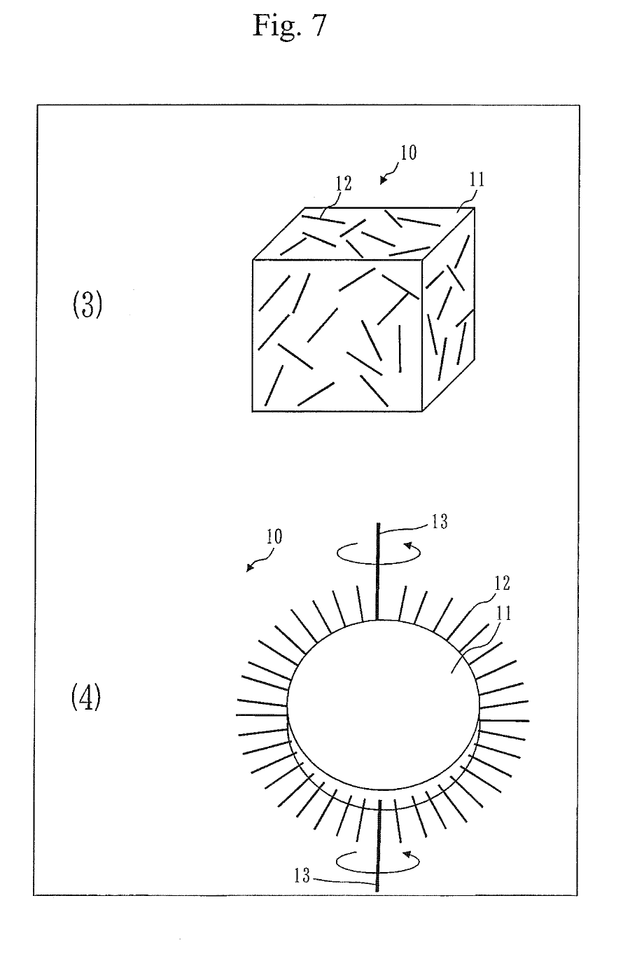

FIGS. 6 and 7 illustrate other examples of the reflector 10 according to Embodiment 1.

As illustrated in (1) of FIG. 6, the main body 11 of the reflector 10 may have a triangular pyramidal shape or any other shape (for example, a rectangular parallelepiped). The reflector 10 illustrated in (1) of FIG. 6 has a plurality of conductor wires 12 perpendicular to the surface of the main body 11.

As illustrated in (2) of FIG. 6, the main body 11 of the reflector 10 may have a hemispherical shape. The plurality of conductor wires 12 may be provided to part of the main body 11, and not entirely on the main body 11. The reflector 10 illustrated in (2) of FIG. 6 has the plurality of conductor wires 12 on the spherical surface portion of the hemispherical main body 11, and not on the bottom surface portion of the hemispherical main body 11.

As illustrated in (3) of FIG. 7, the plurality of conductor wires 12 may be arranged planarly on the surface of the main body 11, and not project from the main body 11.

As illustrated in (4) of FIG. 7, the plurality of conductor wires 12 may be arranged on the entire side surface of the main body 11, and not on the front and rear surfaces of the main body 11. A rotation shaft 13 may be provided to the side-surface portion of the main body 11, and the main body 11 may be rotated about the rotation shaft 13 as the axis.

If the reflector 10 as illustrated in FIGS. 5 to 7 is attached to the vessel, the SAR processing device 30 (see FIG. 2) of the SAR satellite 22 can search for a vessel to which the reflector 10 is attached.

Note that the reflector 10 may be attached to a mobile body (for example, an automobile) other than a vessel, and be used to search for a mobile body other than a vessel.

According to Embodiment 1, even when the radar wave is transmitted and received up in the sky in order to carry out wide-range search, the radar reflected by the reflector 10 can be detected and a mobile body (for example, a vessel) to which the reflector 10 is attached can be searched for.

If a reflector 10 with polarizing characteristics being studied in advance is used, the polarizing characteristics indicating the oscillating direction of the polarized wave and the intensity with which the polarized wave is scattered backward, then a multi-polarimetric radar can be calibrated as will be described hereinafter. The SAR processing device 30 compares the intensity of the received backscattering with the intensity of the known backscattering studied in advance of the reflector 10, and performs various types of calibration in accordance with the comparison result (intensity difference). For example, if the intensity of the received backscattering has a value twice the intensity of the known backscattering, the SAR processing device 30 corrects the value of the intensity of the received backscattering to half the value, and generates a SAR image using the data on the corrected backscattering.

In particular, the reflector 10 illustrated in FIG. 5 or in (2) of FIG. 6 has a shape that scatters each polarized wave backward with the same intensity, whatever incident angle (or off-nadiar angle) the polarized wave may enter at. Thus, this reflector 10 is effective in calibrating the multi-polarimetric radar that outputs a radio wave at incident angles in a wide range.

In Embodiment 1, for example, a reflector (10) as follows has been described. The reference numerals or names of relevant constituent elements, out of constituent elements described in the embodiment, are indicated in parentheses.

The reflector has a main body (11) and a plurality of linear radio wave scattering bodies (12) provided to the main body in different orientations.

At least any one radio wave scattering body out of the plurality of radio wave scattering bodies causes a radio wave entering while oscillating in a specific oscillating direction, to oscillate in a direction different from the specific oscillating direction, to reflect the radio wave in an incident direction in which the radio wave has entered.

The main body forms a three-dimensional shape, and the plurality of radio wave scattering bodies are arranged on the entire outer surface of the main body.

The plurality of radio wave scattering bodies project from the main body such that the plurality of radio wave scattering bodies are arranged on the entire outer surface of the main body.

The plurality of radio wave scattering bodies project from the main body radially to have the central portion of the main body as the center.

The main body forms a spherical shape, and the plurality of radio wave scattering bodies project from the main body radially to have the central portion of the main body as the center, so that the reflecting body forms a spherical shape as a whole.

The main body foams a three-dimensional shape, and the plurality of radio wave scattering bodies project from the main body radially to have the central portion of the main body as the center, so that the plurality of radio wave scattering bodies are arranged on part of the outer surface portion of the main body.

The main body is made of a radio wave transmitting material through which the radio wave is transmitted.

The reflector is attached to a mobile body being a detection target.

In Embodiment 1, for example, a reflecting body detecting device (30) as follows has been described. The reference numerals or names of relevant constituent elements, out of constituent elements described in this embodiment, are indicated in parentheses.

The reflecting body detecting device has a polarized wave transmitting part (31), a polarized wave receiving part (32), and a reflecting body detecting part (33).

The polarized wave transmitting part transmits a radio wave oscillating in a specific oscillating direction, as a transmission polarized wave.

The polarized wave receiving part receives a radio wave, being the transmission polarized wave transmitted by the polarized wave transmitting part and reflected where the transmission polarized wave travels to, to be scattered backward, as the reception polarized wave.

The reflecting body detecting part determines whether or not a reflecting body (the reflector 10 or a mobile body to which the reflector 10 is attached) which causes the transmission polarized wave to oscillate in a direction different from the oscillating direction of the transmission polarized wave, to reflect the transmission polarized wave, is located where the transmission polarized wave travels to, based on the reception result of a reception polarized wave oscillating in an oscillating direction that is different from the oscillating direction of the transmission polarized wave, among the reception polarized waves received by the polarized wave receiving part.

The reflecting body detecting device is provided to a flying object which flies up in the sky above the reflecting body, and transmits the transmission polarized wave and receives the reception polarized wave up in the sky above the reflecting body.

### Embodiment 2

A reflector that has a planar shape, instead of a three-dimensional shape, will be described. Matters that are different from Embodiment 1 will mainly be described hereinafter. Matters that are not described are the same as Embodiment 1.

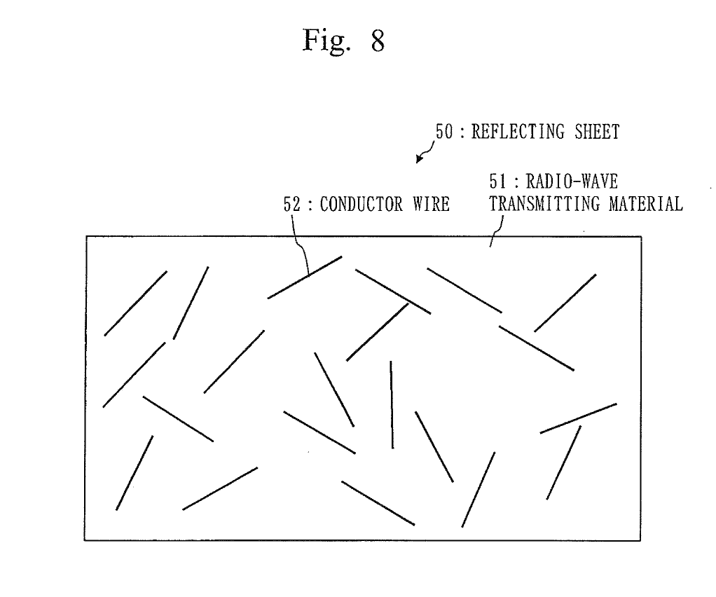

FIG. 8 illustrates a reflecting sheet 50 according to Embodiment 2.

The reflecting sheet 50 according to Embodiment 2 will be described with reference to FIG. 8.

The reflecting sheet 50 (an example of a reflector) is provided to the surface of at least part of a mobile body. For example, the reflecting sheet 50 is spreaded on or adhered to the deck of a vessel. Also, the reflecting sheet 50 may be hung on the mast or the like of the vessel.

The reflecting sheet 50 (an example of the reflector) has a planar radio wave permeating material 51 (for example, a fabric) and a plurality of conductor wires 52 arranged on the planar radio wave permeating material 51 planarly in random orientations.

The plurality of conductor wires 52 are embedded in the radio wave permeating material 51 or adhered to the surface of the radio wave permeating material 51.

Other features of the conductor wires 52 such as the length, thickness, and shape are the same as those of the conductor wires 12 described in Embodiment 1.

By arranging the plurality of conductor wires 52 in the random orientations, in whichever direction the radar wave may enter, at least one conductor wire 52 can change the oscillating direction of the incident radar wave and scatter the incident radar wave backward in the incident direction.

The reflecting sheet 50 provides the same effect as that of the reflector 10 described in Embodiment 1.

As the reflecting sheet 50 is foldable, it can be handled easily when it is not in use and to be stored away, or when it is to be carried for use.

The reflecting sheet 50 can also be used when camouflaging an object (for example, a mobile body).

In this case, in order to camouflage the object, the object is covered with the reflecting sheet 50. Thus, radar waves for detecting the object can be scattered backward in random oscillating directions. At this time, a radar device cannot distinguish the radar wave scattered backward by the reflecting sheet 50 and a radar wave that is volume-scattered by woods or clouds, from each other, and accordingly cannot detect a mobile body.

In Embodiment 2, for example, a reflector (50) as follows has been described. The reference numerals or names of relevant constituent elements, out of constituent elements described in this embodiment, are indicated in parentheses.

The main body (radio wave permeating material 51) is a planar sheet, and a plurality of radio wave scattering bodies (52) are arranged on the sheet planarly in different orientations.

The plurality of radio wave scattering bodies are arranged on the entire surface of the sheet in random orientations.

The sheet is made of a radio wave transmitting material. The reflector is provided to the surface of at least part of the mobile body being a detection target.

### Embodiment 3

Embodiments 1 and 2 have described the embodiments in which the three-dimensional reflector 10 or the planar reflecting sheet 50 is attached to a mobile body.

Note that the mobile body may be coated with a coating containing a plurality of conductor wires. A radar wave entering the mobile body while oscillating in a specific oscillating direction is caused to oscillate in a different direction by at least any one conductor wire out of the plurality of conductor wires contained in the coating applied to the mobile body, so that the incident radar wave can be reflected in the incident direction in which the radar wave has entered.

Therefore, by coating the mobile body with the coating containing the plurality of conductor wires, the same effect as that of the reflector 10 and reflecting sheet 50 can be obtained.

In the embodiments, the conductor wires may be replaced by dielectric wires made of a dielectric material. For example, thin elongated wooden members (an example of the dielectric wires) may be used in place of the conductor wires. The higher the dielectric constant, the higher the intensity of backscattering. Hence, dielectric wires having a high dielectric constant are preferable.

Alternatively, thin elongated linear radio wave scattering body (excluding conductor wires or dielectric wires) which scatters (reflects) the radio wave may be employed in place of the conductors or dielectric wires.

### REFERENCE SIGNS LIST

10: reflector; 11: main body; 12: conductor wires; 13: rotation shaft; 20: sea surface; 21: search vessel; 22: SAR satellite; 23: SAR; 30: SAR processing device; 31: radar wave sending part; 32: radar wave receiving part; 33: vessel detecting part; 39: SAR image generating part; 41: sea-surface scattering; 42: reflector scattering; 50: reflecting sheet; 51: radio wave transmitting material; 52: conductor wires; 90: reflector; 91: trihedral corner

1. A reflector comprising:
a main body; and
a plurality of linear radio wave scattering bodies provided to the main body in different orientations,
wherein at least any one radio wave scattering body out of the plurality of radio wave scattering bodies causes a radio wave entering while oscillating in a specific oscillating direction, to oscillate in a direction different from the specific oscillating direction, to reflect the radio wave in an incident direction in which the radio wave has entered.

2. The reflector according to claim 1, wherein the main body forms a three-dimensional shape, and the plurality of radio wave scattering bodies are arranged on an entire outer surface of the main body.

3. The reflector according to claim 2, wherein the plurality of radio wave scattering bodies project from the main body such that the plurality of radio wave scattering bodies are arranged on the entire outer surface of the main body.

4. The reflector according to claim 3, wherein the plurality of radio wave scattering bodies project from the main body radially to have a central portion of the main body as a center.

5. The reflector according to claim 4, wherein the main body forms a spherical shape, and the plurality of radio wave scattering bodies project from the main body radially to have the central portion of the main body as the center, so that the reflecting body forms a spherical shape as a whole.

6. The reflector according to claim 1, wherein the main body forms a three-dimensional shape, and the plurality of radio wave scattering bodies project from the main body radially to have a central portion of the main body as a center, so that the plurality of radio wave scattering bodies are arranged on part of an outer surface portion of the main body.

7. The reflector according to claim 1, wherein the main body is made of a radio wave transmitting material through which the radio wave is transmitted.

8. The reflector according to claim 1, which is attached to a mobile body being a detection target.

9. The reflector according to claim 1, wherein the main body is a planar sheet, and the plurality of radio wave scattering bodies are arranged on the sheet planarly in different orientations.

10. The reflector according to claim 9, wherein the plurality of radio wave scattering bodies are arranged on an entire surface of the sheet in random orientations.

11. The reflector according to claim 9, wherein the sheet is made of a radio wave transmitting material through which the radio wave is transmitted.

12. The reflector according to claim 9, which is provided to a surface of at least part of the mobile body being a detection target.

13. A reflective coating that contains a plurality of linear radio wave scattering bodies, wherein when the reflective coating is applied, at least any one radio wave scattering body out of the plurality of radio wave scattering bodies causes the radio wave entering while oscillating in a specific oscillating direction, to oscillate in a direction different from the specific oscillating direction, to reflect the radio wave in an incident direction in which the radio wave has entered.

14. The reflective coating according to claim 13, which is applied to a surface of at least part of the mobile body being a detection target.

15. A reflecting body detecting device comprising:
a polarized wave transmitting part that transmits a radio wave oscillating in a specific oscillating direction, as a transmission polarized wave;
a polarized wave receiving part that receives a radio wave, being the transmission polarized wave transmitted by the polarized wave transmitting part and reflected where the transmission polarized wave travels to, to be scattered backward, as the reception polarized wave; and
a reflecting body detecting part that determines whether or not a reflecting body which causes the transmission polarized wave to oscillate in an oscillating direction different from the oscillating direction of the transmission polarized wave, to reflect the transmission polarized wave, is located where the transmission polarized wave travels to, based on the reception result of a reception polarized wave oscillating in an oscillating direction that is different from the oscillating direction of the transmission polarized wave, among the reception polarized waves received by the polarized wave receiving part.

16. The reflecting body detecting device according to claim 15, which is provided to a flying object which flies up in the sky above the reflecting body, and transmits the transmission polarized wave and receives the reception polarized wave up in the sky above the reflecting body.
